(19) United States
(12) Patent Application Publication
(10) Pub. No.: US 2010/0244729 A1
(43) Pub. Date: Sep. 30, 2010

(54) Gazing Ball Having A Battery-Powered LED Device

(75) Inventors: David CHEN, Lewis Center, OH (US); Leighton Chen, Lewis Center, OH (US)

Correspondence Address: STANDLEY LAW GROUP LLP, 6300 Riverside Drive, Dublin, OH, 43017, US

(73) Assignee: AMERIHUA INTERNATIONAL ENTERPRISES INC., Lewis Center, OH (US)

(21) Appl. No.: 12/750,266

(22) Filed: Mar. 30, 2010

Related U.S. Application Data
(60) Provisional application No. 61/164,697, filed on Mar. 30, 2009.

(51) Int. Cl. H05B 37/02; F21L 4/00

(52) U.S. Cl. 315/291; 362/186

(57) ABSTRACT

An illumination device comprising: (a) a substantially spherical and semi-transparent gazing ball having a base with a sidewall; (b) a base cap with a channel corresponding to the sidewall of the base of the gazing ball; (c) an LED device within the base cap; (d) a battery in electrical communication with the LED device and (e) a switch for establishing and removing the electrical communication between the LED device and battery.

### CROSS-REFERENCE TO RELATED APPLICATIONS

This application is a non-provisional patent application and claims priority U.S. Application Ser. No. 61/164,697 filed Mar. 30, 2009 and is hereby incorporated by reference.

### TECHNICAL FIELD

Exemplary embodiments relate generally to a decorative home gazing ball with an internal, battery-powered LED device.

### BACKGROUND OF THE ART

Devices for illuminating the exterior of a home are known and they range from functional devices such as flood lights, walkway lights, and lamp posts to decorative items such as lanterns and gazing balls. Traditional methods for powering these devices consisted of hard-wiring the devices from power sources found inside the home and necessitated running power wires along the ground surface or buried beneath the grade level. More modern methods permit the use of small, localized solar panels which power re-chargeable batteries within the light fixtures. While solar methods remove the need for running wires, existing solar technologies still suffer many drawbacks, including expense, durability, and limitations based on climate.

### SUMMARY OF THE EXEMPLARY EMBODIMENTS

Embodiments herein provide battery-powered LED devices within gazing balls. Some embodiments may utilize circuitry which varies the power levels which are sent to the LEDs in a random manner. This random variation in power correlates to a random variation in the illumination in the LEDs and simulates a ‘flicker’ which is familiar to most consumers as the illumination from a common candle wick. The LEDS, battery, and associated circuitry may fit within a cap which can attach to the base of the gazing ball in order to seal out elemental factors (humidity, insects, etc.). While a manual switch can be included so that users can manually turn on and off the LED device, exemplary embodiments contain a means for automatically turning on-off the LED devices. Some embodiments may use a timer which can be set to have the device illuminate the LEDs during a specific time period during each day. Other embodiments may use a photosensor in electrical communication with the LED device so that when the surrounding level of ambient light passes below a pre-determined threshold, the LED device will illuminate. In other words, the device would energize at dusk, remain energized throughout the night, and turn off at dawn.

Further features of the invention will be described or will become apparent in the course of the following detailed description.

### BRIEF DESCRIPTION OF THE DRAWINGS

A better understanding of the exemplary embodiments will be had when reference is made to the accompanying drawings, wherein identical parts are identified with identical reference numerals, and wherein:

FIG. 1 is an exploded view showing a basic embodiment of the gazing ball, LED device, and base cap.

FIG. 2A is a cross-sectional view showing one embodiment for the base cap.

FIG. 2B is a perspective view showing the embodiment for the base cap from FIG. 2A.

FIGS. 3 and 4 are exploded views showing further embodiments for the gazing ball, LED device, and base cap.

### DETAILED DESCRIPTION OF PREFERRED EMBODIMENTS

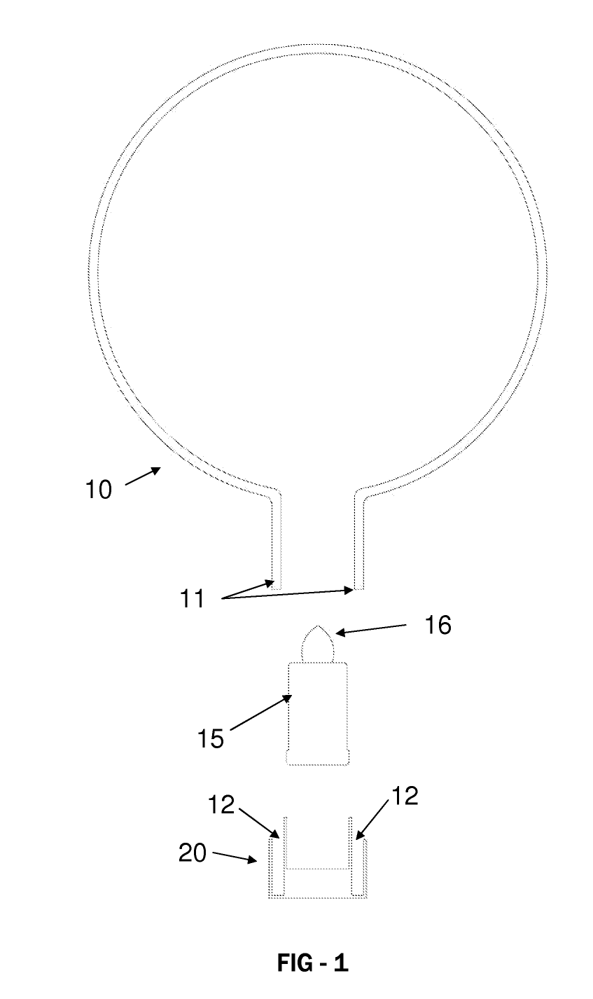

As shown in FIG. 1, the gazing ball 10 may be a generally spherical device with a relatively thin sidewall. The gazing ball 10 may be constructed of any semi-transparent material, including but not limited to a variety of plastics and glass. Near the base of the generally spherical gazing ball 10 may be a ring having a thin sidewall 11, which is adapted to fit within channels 12 of the base cap 20. An interference fit between the gazing ball sidewall 11 and channels 12 may be used in some exemplary embodiments to facilitate a secure connection between the base cap 20 and the gazing ball 10. For this embodiment, the base cap 20 may preferably be comprised of a plastic material, and even more preferably an elastomeric plastic material, to provide a secure and water-tight connection between the base cap 20 and gazing ball 10.

Alternatively, the sidewall 11 and channels 12 may have corresponding threads where the base cap 20 would effectively ‘screw’ onto the base of the gazing ball 10. These connections can further ensure that the base cap 20 does not become disconnected from the gazing ball 10 and can also ensure that elemental factors cannot enter the gazing ball 10. Elemental factors such as humidity and insects may be particularly harmful to the LED device 15.

For the embodiment shown in FIG. 1, the LED device 15 fits within the base cap 20, prior to connecting the base cap 20 with the gazing ball 10. However, in other embodiments, the LED device 15 may be incorporated into the base cap 20. Particularly, this combination may be beneficial if a manual switch for turning on the LED device will be used. By combining the LED device 15 with the base cap 20, a manual switch can be placed on the exterior of the base cap 20 so that a user can easily access the switch to energize the LED device. For embodiments similar to FIG. 1 (where the LED device 15 and base cap 20 are separate pieces), the user may have to remove the base cap 20 from the gazing ball 10 so that a manual switch for the LED device 15 could be accessed. Of course, those skilled in the art could also place an access aperture (ex. notch or hole) in the base cap so that a manual switch could still be accessed, without having to combine the LED device and the base cap and without having to remove the base cap from the gazing ball. Those skilled in the art could also locate a switch in any number of accessible locations while electrically connecting the switch to the LED device.

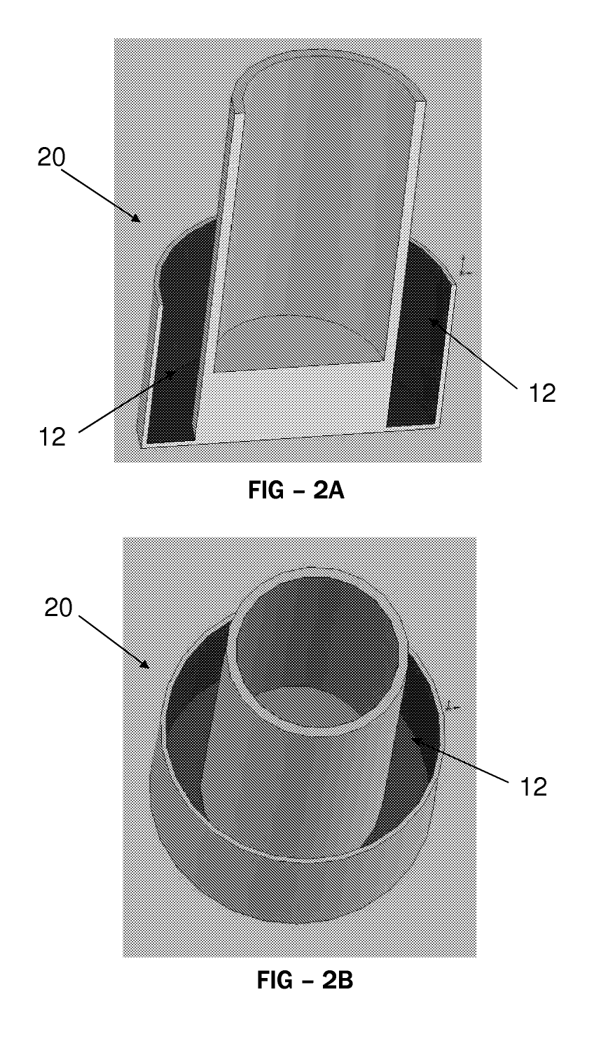

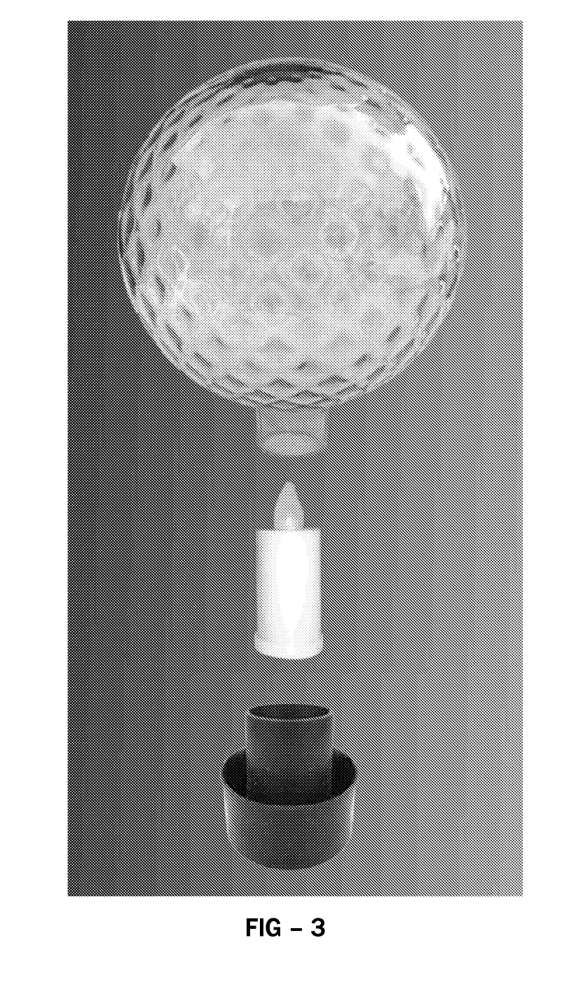

FIG. 2A shows a cross-section of the base cap 20 and provides another view of the channels 12 which accept the sidewall 11 (shown in FIG. 1) of the gazing ball. FIG. 2B shows a perspective view of the same base cap 20 from FIG. 2A.

The LED device 15 may contain a single LED or an array of several LEDs. White LEDs, red LEDs, or any mixture of colored LEDs may be used. Some exemplary embodiments may use a plurality of different colored LEDs and corresponding circuitry so that the color of the light from the LED device can change periodically. The LEDs may be covered with a plastic or glass covering 16 which may also tint the color of the resulting light from the LEDs and the shape of the covering 16 may further simulate the look of a natural candle.

As discussed above, the LED device 15 may contain circuitry which varies the power levels sent to the LEDs in a random manner. This random variation in power correlates to a random variation in the illumination in the LEDs and simulates a ‘flicker’ which is familiar to most consumers as the illumination from a common candle wick. One example of this type of circuitry can be found in U.S. Publication No. 2003/0189825, filed on Apr. 3, 2002 which discloses a microcontroller and pulse width modulation circuit for simulating a multitude of light effects within a Halloween pumpkin. This publication is herein incorporated by reference in its entirety.

The LED device may be powered by one or more batteries (not shown). The use of batteries allows for a quick and easy installation and does not rely on high levels of sunlight in order to charge solar cells. LEDs are known to produce intense light levels while drawing a relatively low amount of electrical current. This characteristic of LEDs allows the use of batteries with relatively infrequent changing of depleted batteries. In exemplary embodiments, the base cap should be designed for easy removal so that batteries can be easily changed. As discussed above, an interference fit or corresponding threads can provide for easy attachment and removal of the base cap to the gazing ball.

In order to conserve the operating life of the battery, the LEDs may be energized through a manual (discussed above) or automatic switch. In some embodiments, a timer may be incorporated into the LED device and the user may set the timer so that the LEDs are energized for a certain time period during each day. Perhaps a user may energize the LEDs during dusk (ex. 7:30-10:30 p.m.) while the light may be enjoyed, but the LEDs will remain off throughout the night. Other users may wish to energize the LEDs at dusk and they might remain on until early morning (ex. 5:00 a.m.). Other embodiments may use a photosensor (not shown) in order to sense the amount of ambient light, where the LEDs may be energized once the level of ambient light falls below a threshold value. This embodiment only energizes the LEDs when they would be visible and would also automatically adjust for the varying times of sunrise/sunset (dawn/dusk) throughout the various seasons.

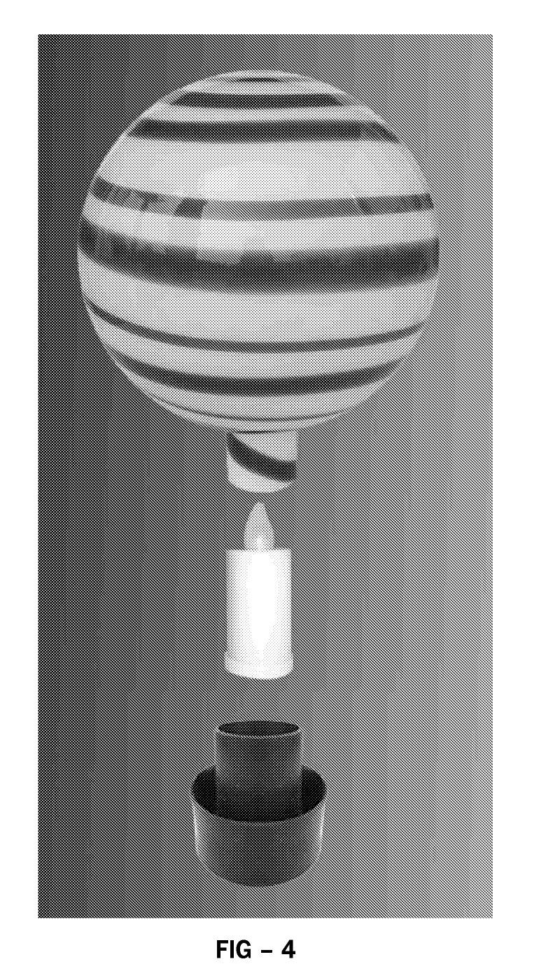

FIGS. 3 and 4 show exploded views of decorative embodiments for the gazing ball, LED device, and base cap.

Having shown and described preferred embodiments, those skilled in the art will realize that many variations and modifications may be made to affect the described embodiments and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is clamed is:

1. An illumination device comprising:
a substantially spherical and semi-transparent gazing ball having a base with a sidewall;
a base cap with a channel corresponding to the sidewall of the base of the gazing ball;
an LED device within the base cap;
a battery in electrical communication with the LED device; and
a switch for establishing and removing the electrical communication between the LED device and battery.

2. The illumination device from claim 1 further comprising:
electrical circuitry in electrical communication with the battery which varies the power levels sent from the battery to the LED device.

3. The illumination device from claim 1 further comprising:
a photosensor in electrical communication with the switch.

4. The illumination device from claim 1 further comprising:
a timer in electrical communication with the switch.
